(19) United States
(12) Patent Application Publication
(10) Pub. No.: US 2009/0182559 A1
(43) Pub. Date: Jul. 16, 2009

(54) CONTEXT SENSITIVE MULTI-STAGE SPEECH RECOGNITION

(76) Inventors: Franz Gerl, Neu-Ulm (DE); Christian Hillebrecht, Blaustein (DE); Roland Romer, Burlafingen (DE); Ulrich Schatz, Goppingen (DE)

Correspondence Address: HARMAN - BRINKS HOFER CHICAGO;Brinks Hofer Gilson & Lione, P.O. Box 10395, Chicago, IL, 60610, US

(21) Appl. No.: 12/247,201

(22) Filed: Oct. 7, 2008

(30) Foreign Application Priority Data
Oct. 8, 2007 (EP) 07019654.8

(51) Int. Cl. G10L 15/26

(52) U.S. Cl. 704/235; 704/E15.043

(57) ABSTRACT

A system enables devices to recognize and process speech. The system includes a database that retains one or more lexical lists. A speech input detects a verbal utterance and generates a speech signal corresponding to the detected verbal utterance. A processor generates a phonetic representation of the speech signal that is designated a first recognition result. The processor generates variants of the phonetic representation based on context information provided by the phonetic representation. One or more of the variants of the phonetic representation selected by the processor are designated as a second recognition result. The processor matches the second recognition result with stored phonetic representations of one or more of the stored lexical lists.

### PRIORITY CLAIM

This application claims the benefit of priority from European Patent 07019654.8 dated Oct. 8, 2007, which is incorporated by reference.

### BACKGROUND OF THE INVENTION

1. Technical Field

This disclosure relates to speech recognition and more particularly to context sensitive modeling.

2. Related Art

During speech recognition processes, verbal utterances are captured and converted into electronic signals. Representations of the speech may be derived that may be represented by a sequence of parameters. The values of the parameters may estimate a likelihood that a portion of a waveform corresponds to a particular entry.

Speech recognition systems may make use of a concatenation of phonemes. The phonemes may be characterized by a sequence of states each of which may have a well-defined transition. To recognize spoken words, the systems may compute a likely sequence of states.

In some circumstances vocabulary may be identified by templates. A recognition mode may select a sequence of simple speech. Such a sequence may be part of a phoneme or a letter. A recognized sequence may serve as an input for further linguistic processing.

In modeling, it may not be practical to enforce contexts. When attempts are made to enforce contexts errors may occur. In some systems, processors cannot sustain the combinational processing that is required. In spite of improvements, many speech recognition systems are not reliable or fail in noisy environments. When a speech recognition process fails other systems may be affected such as speech dialog systems. Therefore, there is a need for a more reliable speech recognition system.

### SUMMARY

A system enables devices to recognize and process speech. The system includes a database that retains one or more lexical lists. A speech input detects a verbal utterance and generates a speech signal corresponding to the detected verbal utterance. A processor generates a phonetic representation of the speech signal that is designated a first recognition result. The processor generates variants of the phonetic representation based on context information provided by the phonetic representation. One or more of the variants of the phonetic representation selected by the processor are designated as a second recognition result. The processor matches the second recognition result with stored phonetic representations of one or more of the stored lexical lists.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a speech recognition process.

FIG. 2 is a second speech recognition process.

FIG. 3 is a speech recognition system.

FIG. 4 is a speech recognition system interfacing a vehicle.

FIG. 5 is a speech recognition system interfacing an audio system and/or a communication system.

FIG. 6 is a third second speech recognition process.

FIG. 7 is a voice segment process.

### DETAILED DESCRIPTION OF THE PREFERRED EMBODIMENTS

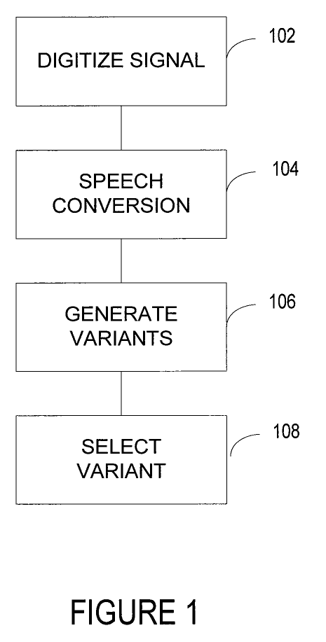

A process enables devices to recognize and process speech. The process converts spoken works into a machine-readable input. In FIG. 1, the conversion occurs by converting a continuously varying signal (e.g., voiced or unvoiced input) into a discrete output 102. The process represents the sounds that comprise speech with a set of distinct characters and/or symbols, each designating one or more sounds 104. Variants of the characters and/or symbols are generated from acoustic features 106. A model may select a variant to represent the sounds that make up speech 108.

The variants may be based on one or more local or remote data sources. The variants may be scored from acoustic features extracted as the process converts the discrete output into the distinct characters and/or symbols. Context models may be used to match the actual context of the speech signal. Some context models comprise polyphone models, such as models that comprise elementary units that may represent a sequence of three phonemes (e.g., triphone models). These models may be generated using a training corpus.

Based on a score, a variant may be selected and transmitted to a local or remote input or interface for further processing. In some processes, the selection may comply with actual polyphone contexts that may apply a fine grained modeling. Because some selected variants are generated from a reasonable prediction, it may comprise a quality phonetic approximation. The process may improve speech recognition, speech control, and verbal human-machine interaction.

A first representation of the sounds that comprise speech may be generated by a loop of context dependent phoneme models. The left and right contexts in a triphone, for example, may contain information about the following or preceding phonemes. This data may be processed to generate new variants.

A recognized phonetic representation of an utterance (e.g., of a word comprising a number of phonemes) may be processed through many processes. Acoustic features (e.g., MEL-frequency perceptual linear prediction PLP cepstral coefficients) of a speech signal may be extracted. A loop of simple speech subunits may deliver the phonetic representation. Such a subunit may be part of one or more phonemes, one or more letters, one or more syllables, or one or more other representations of sound. Through this process, a recognition engine may approximate any word in a language. The first representation (or initial phonetic representation) may be, e.g., one element (the highest scored element) of an N-best list of phonetic representations representing phonetic candidates corresponding to the detected utterance. Some processes benefit by restricting some (or all) valid phonetic representations during this initial stage. There may be benefits in adopting or interfacing an optional phonotactic information process or other methods that restrict some (or all) valid phonetic representations during this initial stage. The speech subunits may be modeled according to their contexts. Some processes may enhance contexts that match the following or preceding phoneme.

Some processes use loops of polyphone phoneme models. A phoneme may comprise a small, a minimal, (or a smallest) unit of speech that may distinguish meaning. In speech recognition, a phoneme may be modeled according to its context as a polyphone model. This mode may accommodate variations that change appearance in sound in the presence of other phonemes (allophonic variations) and transitions between different phonemes. Significant (e.g., important) and/or common phonemes may be modeled with very long contexts, (e.g., up to 5 phonemes called quinphones). For phoneme combinations that are unusual in a particular language and/or dependent upon training material, some processes may not completely enable biphones or monophones models. In these processes, triphones (e.g., using left and right contexts) may be used. Some consonants e.g., /b/ and /p/ may have similar effects if they follow the same vowels. Thus, the triphone models may include models where contexts are clustered in classes of phonemes with similar effects (e.g., triphone class models).

In some processes, alternative sources of information may be processed to generate variants. For instance, a priori knowledge or data stored in a local or a remote memory may retain data on a probability of confusion of recognizing particular phonemes. In some exemplary processes, an initial representation (e.g., a phonetic representation) may comprise one or more phonemes. In a second representation, the variants may be based on a predetermined probability of mistaking one phoneme for another. The mistake, for example, may comprise a long vowel /a:/ that was generated as a variant instead of a previously recognized shorter vowel /a/.

Error may be corrected or compensated for at a second or later processing stage. For instance, unvoiced consonants like “p” or “t” may be mistakenly inserted during a noise event. An optional compensation process (or act) may monitor for such conditions or errors and generate variants without such potential insertions occurring at the beginning or end of the phonetic string (e.g., when a noise event or error is detected that may be identified by a noise monitoring process or noise detector). In an alternative process, variants may be generated such that they differ from each other only for the parts (phonemes) that are recognized with a relatively high degree of uncertainty (measured in terms of acoustic scores or some confidence measure, for example). The probability of a correct second recognition result may be significantly improved. Alternative processes may base or generate variants on a likelihood approach such as N-Best lists or hypothesis graphs.

One process of generating variants analyzes the duration that a certain sound is modeled. Some processes may discard sound models that occur through an unusually short or long interval. An alternative process may establish an order, rating, or precedence when modeling sounds. These processes may be programmed to recognize some sounds in certain languages are more important in a speech recognition process than others. When generating variants, speech may be processed or selected to be processed based on a corresponding rating or precedence. More processing time may be allocated (or devoted) to some sounds and less processing time may be allocated (or devoted) to other sounds.

For relatively short utterances, the number of meaningful variants may be relatively small. For long utterances, the number of meaningful variants may significantly increase. Such an increase (at a second state may) make increase processing time and may, in some instances, create delays. The delays may affect some optional processes or acts that validate or check variants before or after a variant selection. In these processes, the validation or check may be temporarily suspended until a long utterance is completed.

To minimize delays, another alternative method that recognizes speech may split an utterance into two, three, or more (e.g., several) intervals. Some processes divide or establish the intervals in the time or digital domains based on prosodic features of the verbal utterance. The interval division may be based on speech pauses that may be detected or perceived in the verbal utterance. Intonation, rhythm, and focus in speech may also be monitored or analyzed to detect natural breaks in a received utterance. The syllable length, loudness, pitch and formant structure and/or the lexical stress are analyzed or processed in other alternative processes when dividing the speech signal into intervals.

When a process is faced with generating a large number of potential variants (even for a frame of a speech signal) and/or if the fragmentation of a speech signal is challenging (e.g., requires large processing time) due to insufficient or ambiguous prosodic information, a second stage may be supplemented by one or more subsequent stages for generating further variants. In some processes, partial solutions of different recognition stages are combined to obtain an optimal recognition result. This combination may replace or supplements the second stage (that follows the initial stage). In an exemplary process, an output of a second (or later) stage is processed to generate and score variants in one or more later stages (e.g., a third recognition stage, a fourth stage, etc.). In an exemplary three stage process, parts of the second result (e.g., recognized with a high confidence measure) and parts of a variant obtained in the third stage are combined to obtain a final phonetic representation of the detected utterance.

The processes and methods disclosed may access a local or remote database. The database may retain phonetic representations of entries of one or more lexical lists that may be linked or associated through grammar. Database entries may be scored against the variants generated by a second stage using the acoustic features that are described in this Written Description. An entry within a lexical list (e.g., some command phrase such as “stop”, “abort”, etc.), that matches the utterance of an operator, may be detected by an alternative process and preferred in some applications to a optimal phonetic variant of a second stage.

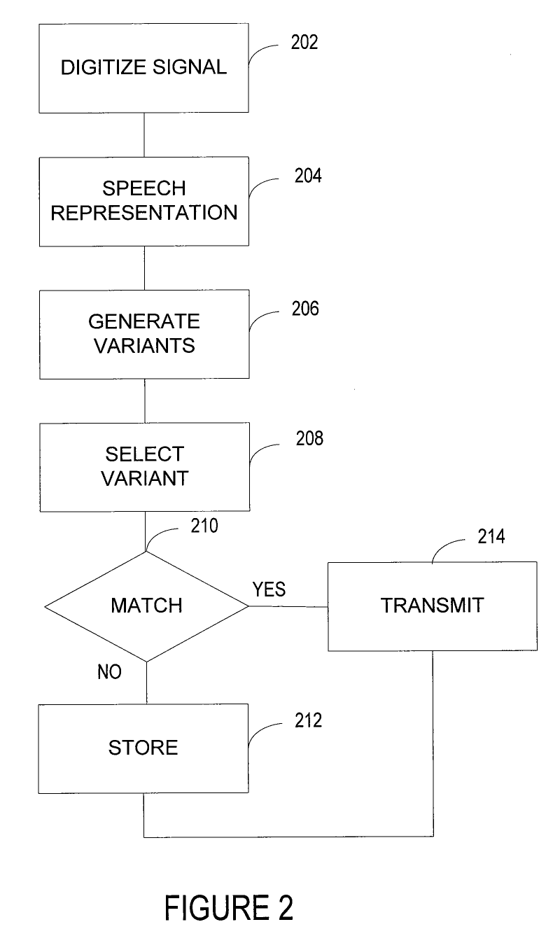

In another alternative process shown in FIG. 2, a continuously varying signal (e.g., voiced or unvoiced speech) is converted into a discrete output at 202. The process represents the sounds that comprise speech with a set of distinct characters and/or symbols, each designating one or more sounds (e.g., a phonetic or first representation) at 204. Variants of the characters and/or symbols may be generated from context information provided through the phonetic representation at 206. The phonetic representation may be provided by a training corpus comprising a polyphone model, (e.g., a triphone model or other methods). A model may select a variant to represent the sounds that make up speech and designate the selected variant as a second recognition result at 208. The process matches the second recognition result with stored phonetic representations of entries of one or more lexical lists retained in a local or remote databases at 210. The matching may occur through a comparison of acoustic scores of the second recognition result with acoustic scores of stored phonetic representations of entries that make up the lexical list. If the phonetic representations of the entries of the one or more stored lexical list do not match the second recognition result (verbal utterance) by a predetermined threshold (e.g., a measure of similarity or a probability), the second recognition result may be stored or added to the database(s) that retain the phonetic representations at 212. When stored the result may be further processed or transmitted to a local or remote device at optional 214

Unlike some processes, the generation of variants of the first recognition result may increase the reliability of the speech recognition process. When a processor executes the process, the template or voice tag (new entry in the database of stored phonetic representations) generated may be closer to the actual phonetics of the utterance. Reliability improves some systems because the context information that is processed to generate the second recognition increases recognition.

In the alternative process of FIG. 2, the phonetic representation may comprise phoneme variants. In some processes the variants are based on a priori information or data (e.g., a predetermined probability of mistaking one phoneme for another). The variants may be scored and the second recognition result generated may be based on the scores of the variants of the phonetic representations. Like the processes described, this process may further divide a verbal utterance into intervals based on prosodic information (such as speech pauses or the other information previously or later described).

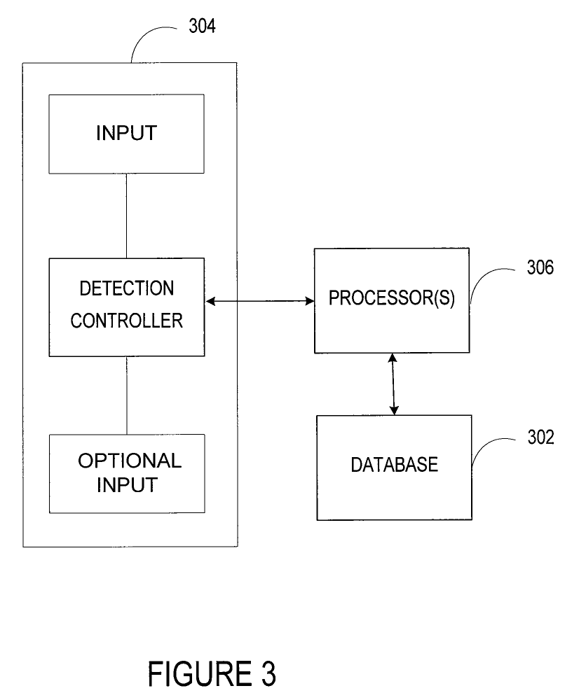

When retained in a computer readable storage medium the process may comprise computer-executable instructions. The instructions may provide access to a database 302 (shown in FIG. 3) comprising one or more lexical lists. A speech input 304 (e.g., one or more inputs and a detection controller) may be configured to detect a verbal utterance and to generate a speech signal corresponding to the detected verbal utterance. One or more processors (or controllers) 306 may be programmed to recognize the verbal utterance by generating phonetic representation of the speech signal and designating the result as a first recognition result. The processor(s) 306 may generate variants of the phonetic representation. The variants may be based on context information previously stored in the database 302 for the phonetic representation. The processor(s) 306 may designate a second recognition result when it selects one or more variants of the phonetic representation and then match the second recognition result with stored phonetic representations of entries of the one or more stored lexical lists. The processor(s) 306 may transmit the second recognition result through a tangible or virtual bus to a remote input, interface, or device.

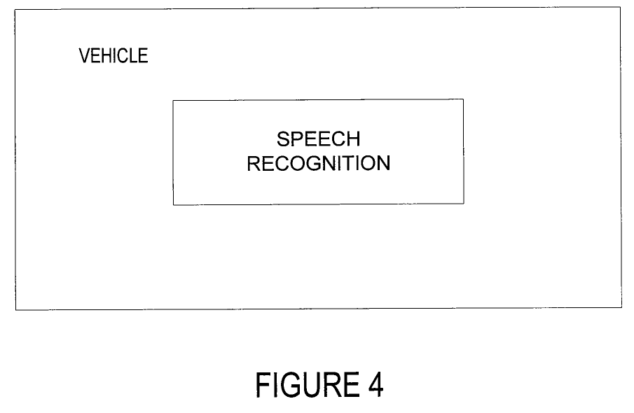

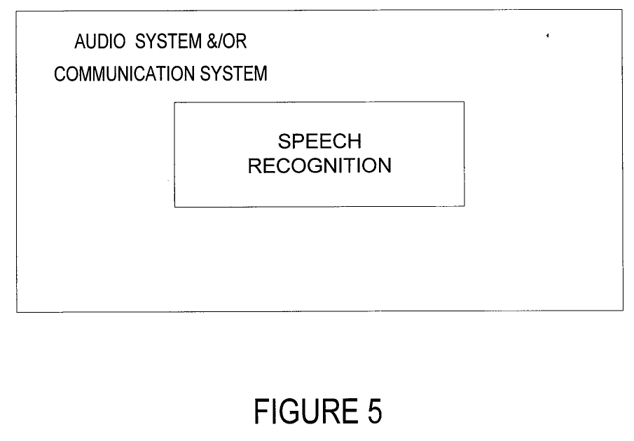

The processors (or controllers) 306 may be integrated with or may be a unitary part of an embedded system. The system may comprise a navigation system for transporting persons or things (e.g., a vehicle shown in FIG. 4), interface (or is a unitary part of) a communication (e.g., wireless system) or audio system shown in FIG. 5 or may be provide speech control for mechanical, electrical, or electro-mechanical devices or processes. The speech input 304 may comprise one or more devices that convert sound into an operational signal. It may comprise one or more sensors, microphones, or microphone arrays that may interface an adaptive or a fixed beamformer (e.g., a signal processor that interfaces the input sensors or microphones that may apply weighting, delays, etc. to combine the signals from the input microphones). In some systems, the speech input interface may comprise one or more loudspeakers. The loudspeakers may be enabled or activated to transmit a recognition result or a stored phonetic representation of an entry of one or more lexical lists, respectively.

In an alternative system, the speech recognition processors (or controllers) 306 are further configured to add the second recognition result to the stored phonetic representations within a local or remote memory or the database 302. The addition to the memory or the database 302 may occur when the phonetic representations of the entries of the one or more stored lexical list do not match (or the comparison does not indicate a match within or greater than a programmed probability or confidence level). Through this optional system, the speech recognition system may be programmed to enroll voice sample, e.g., a sample of a voice is detected, processed, and a voice print (voice tag) is generated and stored in the memory or database 302.

The speech recognition processors (or controllers) 306 may be configured to generate the variants based on the described context information or data (e.g., provided by a triphone model used for the speech recognition). Some processors (or controllers) 306 are further configured to generate variants based on one or more of the described methods. An exemplary system may program or configure a processor (or controller) 306 to generate variants, based on a predetermined probability of mistaking one phoneme for another. Further information or data, e.g., referring to a possible known occurrence that voiceless consonants, e.g., “p” or “t”, may be mistakenly recognized at the very end of a detected utterance. This knowledge or data may be programmed and processed by the processors (or controllers) 306 to generate the variants of the phonetic representation of the detected utterance that may represents a first recognition result. In some systems the processors (or controllers) 306 may be programmed or configured to score the variants of a phonetic representation. The processors (or controllers) 306 may then generate a second recognition result based on the scores of the variants of the phonetic representation. The scores may comprise acoustic scores or confidence measures of a speech recognition process.

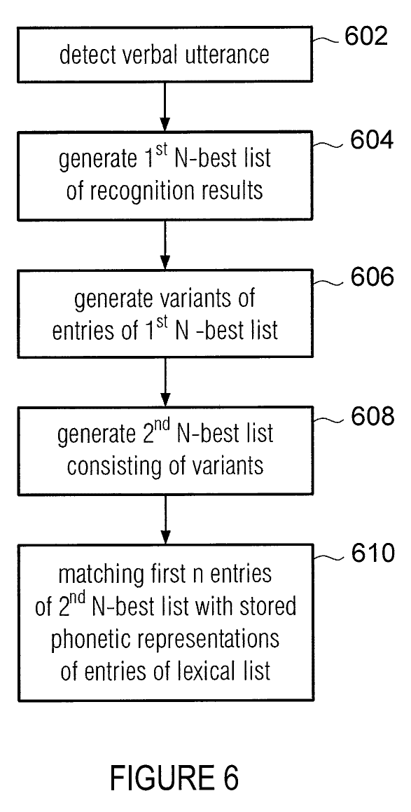

FIG. 6 is a third process that recognizes speech. The process may detect voiced (and unvoiced) speech signals at 602. The process automatically identifies the continuously varying signal that comprises speech before sampling and converting the signal into a discrete or digital output. In the speech waveforms may be sampled at a rate between about 6.6 kHz and about 20 kHz in some processes.

The process may analyze speech signals through a spectral analysis. Representations may be derived from a short term power spectra that represents a sequence of characterizing vectors that may include values that may be known as features or feature parameters. The characterizing vectors may comprise the spectral content of the speech signals and in some processes may be cepstral vectors. A cepstrum process may separate the glottal frequency from the vocal tract resonance. The cepstrum process may derive a logarithmic power spectrum that may be processed by an inverse Fourier transform. In some processes, the characterizing vectors may be derived from a short-term power spectrum. In these processes, the speech signal may divided into speech frames (e.g., of about 10 to about 20 ms in duration). The feature parameters may comprise the power of some predetermined number of discrete frequencies (e.g., 20 discrete frequencies) that may be relevant to identify the string representation of a spoken speech signal.

Based on the identified or selected feature parameters, a first N-best list of phonetic representations of the detected utterance is generated at 604. The entries of the first N-best list may be scored. The scores may represent the probability that a given phonetic representation actually represents a spoken word. The scores may be determined from an acoustic probability model. The model may comprise a Hidden Markov Model or an ANN, other models. Hidden Markov Models may represent one of the dominant recognition paradigms with respect to phonemes. A Hidden Markov Model may comprise a double stochastic model based on the generation of underlying phoneme strings and the surface acoustic representations that may be both represented probabilistically as Markov processes.

By example, acoustic features of phonemes may be processed to determine a score. An “s,” for example, may have a temporal duration of more than about 50 ms and may exhibit many (or primary) frequencies above about 4 kHz. Based on these and other types of occurrences rules may be derived to statistically classify such voice segments. A score may represent distance measures indicating how far from or close to a specified phoneme a generated sequence of characterizing vectors and thereby an associated word hypothesis is positioned.

New variants that correspond to the entries of the N-best list are generated at 606 based on context information. In some processes the context information is based on a model such as a triphone model. In an exemplary triphone model, a phoneme may be recognized based on preceding and consecutive phonemes. Some consonants e.g., /b/ and /p/ may have similar effects if they follow the same vowels. The triphone models may include phonemes where contexts are clustered in classes of phonemes with similar effects (triphone class models).

An exemplary short hand notation of the contexts of a phoneme may be shown by a few examples.

m)a(b shall describe the model of phoneme /a/ with left context /m/ and right context /b/.

l(i: shall describe a biphone of phoneme /l/ with right context /i:/.

By example, consider that a human speaker utters the name “Alina” phonetically represented by ?a:li:na: (where the question mark denotes the glottal stop). The utterance may be detected 602 and, then, an N-best list of recognition results is generated at 604:

RESULT 1: -)?(a ?)a(n l(i: l)i:(b n(a: m)6(- U)p(t

RESULT 2: -)?(a ?)a(n l(i: l)i:(b n(a: m)a(- U)p(t

RESULT 3: -)?(a ?)a(n l(e: l)i:(b n(a: m)a(- U)p(t

The results are shown in a Speech Assessment Methods Phonetic Alphabet (SAMPA) notation, where the brackets indicate left and right contexts, “-” denotes a pause and “6” (ã) is the phonetic representation of an “er” vowel as in the German words “besser” or “Bauer”.

RESULT 1 may be assumed to be a list that scored the highest. A graphemic representation of the first recognition result may be given by “Alinerp”. By the example above, the first recognition result is obtained as well as the context information. The result may be due to the triphone model used in this exemplary speech recognition process. Based on this context, information variants of the first recognition result “?ali:n6p” may be generated, e.g., “?ali:nUp”, “?a:ni:nUp”, “?ani:nap” and “?ali:nap”.

The acoustic features / feature parameters obtained by analyzing the speech signal to obtain a first N-best list may be stored in a volatile or non-volatile memory or database before it is accessed by a second recognition process. A second recognition process may comprise a re-scoring of the variants (including the first recognition result “Alinerp”) based on the stored feature parameters. The process generates a second N-best list that may include some of the variants 4.

Besides the context information a priori known probabilities for confusing particular phonemes may be processed by a processor or controller to generate the variants at 606. Additional background information or data may also be used. For example, commonly voiceless consonants, e.g., “p” or “t”, may be mistakenly recognized at the very end of a detected utterance. By avoiding this mistake, variants without final “p” are also generated by this example.

A predetermined number of entries of the second N-best list with the highest scores may be matched with the locally or remotely stored phonetic representations of entries of one or more lexical lists at 610. A best match may be determined. According to the current example, “Alina” may be selected as the correct list entry that corresponds to the detected verbal utterance.

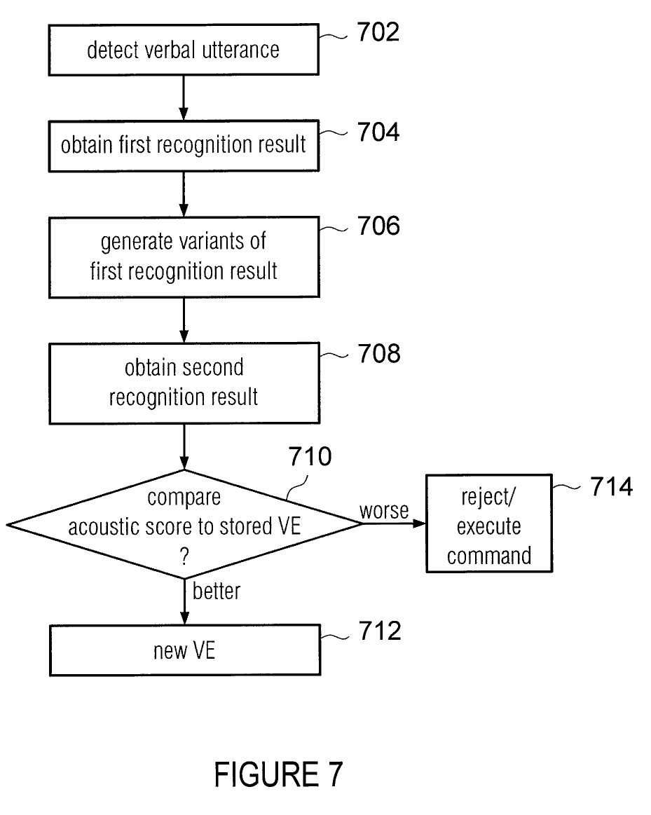

In FIG. 7 a process enrolls a voice segment. The process may detect voiced (and unvoiced) speech signals at 702. The process automatically identifies the continuously varying signal that comprises speech before sampling the speech and converting it into a discrete or digital output. In some systems a communication program may convert the signals received through a microphone or microphones that may operate in tandem (e.g., a microphone array). The microphones may comprise omni-directional microphones distributed about a space such as an interior of a vehicle or near a communication device. In the time domain the speech waveforms may be sampled at a rate between about 6.6 kHz and about 20 kHz.

A first recognition result may be obtained at 704 through an N-best list of word candidates, for example. At 706 variants are generated based on the relevant context information provided by a selected model such as a triphone model. In FIG. 7, the variants are scored and the variants with the highest scores are obtained as a second recognition result at 708. At 710 the scores are compared against scores of stored phonetic representations of entries of a lexical list. Some lexical lists may comprise stored voice enrolments and their associated scores. Comparison with stored commands may also occur through an optional act. A command comparison may facilitate command recognition during an enrolment phase process.

If the acoustic score of a variant (the voice enrolment candidate) is better (e.g. within a predetermined distance measure) than the one of a stored voice enrolment, a new voice enrolment process occurs at 712. A new voice enrollment process may comprise adding a newly trained word to the stored phonetic representations. In some processes, the quality of the voice enrolment may be enhanced by taking two or more voice samples (detected speech signals). If, on the other hand, the score is worse, the voice enrolment candidate is rejected 714. If a command is recognized, this command is executed at 714.

Enrollment is not limited to voice enrollment. Some alternative processes generate and store variants of command phrases. In these processes, a detected speech segment may be recognized as a command before it is compared against stored commands. Based on the differences or deviations from an expected recognized speech, the command may have an associated acoustic score. If an acceptable probability is reached, the command may be mapped to an existing command. This association may be saved in a local or remote memory (or database) to facilitate a reliable recognition of the command when the speaker issues the command again.

Other alternate systems and methods may include combinations of some or all of the structure and functions described above or shown in one or more or each of the figures. These systems or methods are formed from any combination of structure and function described or illustrated within the figures. Some alternative systems or devices compliant with one or more of the mobile or non-mobile bus protocols may communicate with one or more remote controllers, software drivers, and wireless communication devices. In-vehicle wireless connectivity between the nodes and one or more wireless networks may provide alternative high speed connections that allow users or devices to initiate or complete a function at any time within a stationary or moving vehicle.

The methods and descriptions above may be encoded in a signal bearing medium, a computer readable medium or a computer readable storage medium such as a memory that may comprise unitary or separate logic, programmed within a device such as one or more integrated circuits, or processed by a controller or a computer. If the methods or descriptions are performed by software, the software or logic may reside in a memory resident to or interfaced to one or more processors or controllers, a communication interface, a wireless system, a powertrain controller, body control module, an entertainment and/or comfort controller of a vehicle or non-volatile or volatile memory remote from or resident to the a speech recognition device or processor. The memory may retain an ordered listing of executable instructions for implementing logical functions. A logical function may be implemented through digital circuitry, through source code, through analog circuitry, or through an analog source such as through an analog electrical, or audio signals.

The software may be embodied in any computer-readable storage medium or signal-bearing medium, for use by, or in connection with an instruction executable system or apparatus resident to a vehicle or a hands-free or wireless communication system. Alternatively, the software may be embodied in media players (including portable media players) and/or recorders. Such a system may include a computer-based system, a processor-containing system that includes an input and output interface that may communicate with an automotive, vehicle, or wireless communication bus through any hardwired or wireless automotive communication protocol, combinations, or other hardwired or wireless communication protocols to a local or remote destination, server, or cluster.

A computer-readable medium, machine-readable storage medium, propagated-signal medium, and/or signal-bearing medium may comprise any medium that contains, stores, communicates, propagates, or transports software for use by or in connection with an instruction executable system, apparatus, or device. The machine-readable storage medium may selectively be, but not limited to, an electronic, magnetic, optical, electromagnetic, infrared, or semiconductor system, apparatus, device, or propagation medium. A non-exhaustive list of examples of a machine-readable medium would include: an electrical or tangible connection having one or more links, a portable magnetic or optical disk, a volatile memory such as a Random Access Memory “RAM” (electronic), a Read-Only Memory “ROM,” an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled by a controller, and/or interpreted or otherwise processed. The processed medium may then be stored in a local or remote computer and/or a machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method that recognizes speech comprising:
detecting a speech signal representing a voiced or unvoiced segment;
converting the speech signal into a discrete output;
generating a representation of the speech signal as a set of distinct characters or symbols;
designating the representation as a first recognition result;
generating variants of the first recognition result; and
selecting one or more variants of the first representation result as a second recognition result.

2. The method of claim 1 where the phonetic representation comprises phonemes and the variants are based on a predetermined probability of mistaking one phoneme for another phoneme.

3. The method of claim 2 further comprising scoring the variants of the phonetic representation and generating the second recognition result based on the scores of the variants of the phonetic representation.

4. The method of claim 3 where the variants of the phonetic representation are based on context information comprising a polyphone model.

5. The method of claim 3 where the variants of the phonetic representation are based on context information comprising a triphone model.

6. The method of claim 1 further comprising accessing a database comprising phonetic representations of entries of one or more lexical lists scored against variants of the second recognition result using the same acoustic features of the second recognition.

7. The method of claim 1 further comprising dividing the speech signal into speech segment intervals.

8. The method of claim 7 where the division of the speech signal into speech segment intervals is based on a plurality of prosodic features of a verbal utterance.

9. The method of claim 8 where the division of the speech signal into speech segment intervals is based on a plurality of speech pauses included in the verbal utterance.

10. A method of enrolling a voice segment comprising:
detecting a speech signal representing a verbal utterance;
digitizing the detected speech signal;
generating a phonetic representation of the speech signal that is designated a first recognition result;
generating variants of the phonetic representation based on a plurality of context information provided for the phonetic representation;
selecting one or more variants of the phonetic representation that is designated a second recognition result;
matching the second recognition result with stored phonetic representations of entries of one or more stored lexical lists; and
adding the second recognition result to the stored phonetic representations when none of the phonetic representations of the entries of the one or more stored lexical list match the second recognition result better than a predetermined matching threshold.

11. The method of claim 10, further comprising generating an entry in the one or more lexical lists that corresponds to the second recognition result.

12. A computer-readable storage medium that stores instructions that, when executed by processor, cause the processor to recognize speech by executing software that causes the following act comprising:
digitizing a speech signal representing a verbal utterance;
generating a phonetic representation of the speech signal that is designated as a first recognition result;
generating variants of the phonetic representation based on a plurality of context information provided for the phonetic representation;
selecting one or more variants of the phonetic representation that is designated as a second recognition result;
matching the second recognition result with stored phonetic representations of entries of one or more stored lexical lists; and
adding the second recognition result to the stored phonetic representations when the phonetic representations of the entries of the one or more stored lexical list do not match the second recognition result better than a predetermined matching threshold.

13. The computer-readable storage medium of claim 12, further comprising generating an entry in the one or more lexical lists that corresponds to the second recognition result.

14. Speech recognition device, comprising
a database comprising one or more lexical lists;
a speech input interface configured to detect a verbal utterance and configured to generate a speech signal corresponding to the detected verbal utterance;
a processor programmed to:
generate a phonetic representation of the speech signal as a first recognition result;
generate variants of the phonetic representation based on context information provided for the phonetic representation;
select one or more of the variants of the phonetic representation as a second recognition result; and
match the second recognition result with stored phonetic representations of entries of the one or more stored lexical lists.

15. The speech recognition system of claim 14 where the processor is further configured to add the second recognition result to the stored phonetic representations, if none of the phonetic representations of the entries of the one or more stored lexical lists match the second recognition result better than a predetermined matching threshold retained in the database.

16. The speech recognition system of claim 15 where the processor is configured to generate the variants of the phonetic representation based on a predetermined probability of mistaking one phoneme for another phoneme.

17. The speech recognition system of claim 14 where the processor is configured to generate the variants of the phonetic representation based on a predetermined probability of mistaking one phoneme for another phoneme.

18. The speech recognition system of claim 14 where the processor is configured to score the variants of the one phonetic representation and generate the second recognition result based on the scores of the variants of the one phonetic representation.

18. The speech recognition system of claim 14, where the processor is further configured to divide the verbal utterance into intervals.

20. Speech recognition device, comprising
a database comprising one or more lexical lists;
a speech input interface configured to detect a verbal utterance and configured to generate a speech signal corresponding to the detected verbal utterance;
a signal processor in communication with the speech input to beamform the verbal utterance received through a sensor array; and
a processor programmed to:
generate a phonetic representation of the speech signal as a first recognition result;
generate variants of the phonetic representation based on context information provided for the phonetic representation;
select one or more of the variants of the phonetic representation as a second recognition result; and
match the second recognition result with stored phonetic representations of entries of at least one stored lexical list.

21. The speech recognition device of claim 20 where the processor comprises the signal processor.
